(19) United States
(12) Patent Application Publication
(10) Pub. No.: US 2009/0013086 A1
(43) Pub. Date: Jan. 8, 2009

(54) SYSTEM AND METHOD FOR LIVE VIDEO AND AUDIO DISCUSSION STREAMING TO MULTIPLE USERS

(76) Inventor: Yair Greenbaum, Maplewood, NJ (US)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 12/028,779

(22) Filed: Feb. 8, 2008

Related U.S. Application Data
(60) Provisional application No. 60/900,511, filed on Feb. 8, 2007.
(60) Provisional application No. 60/900,517, filed on Feb. 8, 2007.
(60) Provisional application No. 60/906,609, filed on Mar. 13, 2007.
(60) Provisional application No. 60/983,795, filed on Oct. 30, 2007.
(60) Provisional application No. 60/985,101, filed on Nov. 2, 2007.

(51) Int. Cl. G06F 15/16

(52) U.S. Cl. 709/231

(57) ABSTRACT

A network system for providing live video based discussion comprising: a host server for connecting with a plurality of browser clients; a web site having an embedded code that allows a connection between said host server and each of said plurality of browser clients; a media server for receiving first live video and audio data from a first individual browser client and second live video and audio data from a second individual browser client; wherein said host server receives instructions from individual browser clients requesting said first and second live video and audio data and said host server requests said media server to rout said live video and audio data to each individual browser client that requests said live video and audio data; wherein said media server connects with said individual browser client that requests said first and second live video and audio data and streams said first and second live video and audio data to said individual browser client that requests said first and second live video and audio data; and a customized flash video player in each of said plurality of browser clients for receiving said first and second live video and audio data, wherein said first and second live video and audio data are continuously synchronized by said customized flash video player.

### CROSS-REFERENCE TO RELATED APPLICATIONS

The present application claims the benefit of U.S. Provisional Application Ser. No. 60/900,511 filed on Feb. 8, 2007, U.S. Provisional Application Ser. No. 60/900,517, filed on Feb. 8, 2007, U.S. Provisional Application Ser. No. 60/906,609, filed on Mar. 13, 2007, U.S. Provisional Application Ser. No. 60/983,795, filed on Oct. 30, 2007, and U.S. Provisional Application Ser. No. 60/985,101 filed on Nov. 2, 2007, the entireties of which are hereby incorporated by reference.

### FIELD OF THE INVENTION

The present invention relates generally to network systems for the receipt and delivery of audio video and messaging data and specifically to an on-line video debate platform.

### BACKGROUND OF THE INVENTION

The internet enables many ways for people to communicate with each other. As the internet evolves enhanced methods of communicating are becoming possible. Audio and video transmission are an important aspect of communicating between people. Thus website owners are seeking to add video and audio communication to their users. One issue faced by these website owners however is the server capacity required for running such video and audio platforms. Additionally, interactive applications such as video and audio interactions, videophone or interactive games have a real-time constraint. Specifically, the information has a time-bounded usefulness, and if the information arrives, but is late, it is useless. This is equivalent to a maximum acceptable end-to-end latency on the transmitted information, where by end-to-end means to capture, encode, transmit, receive, decode, and display. The maximum acceptable latency depends on the application, but often is on the order of 150 ms. Thus, there is a need for a video and audio discussion platform that site owners can add easily to their website which minimizes the latency of the video and audio data.

### SUMMARY OF THE INVENTION

An object of the present invention is to provide a live video and audio debate platform that can be easily into an affiliate website.

Another object of the present invention is to provide video and audio streaming to individual clients that synchronizes separate video and audio streams so as to avoid latency.

A still further object of the present invention is to provide live and recorded video and audio data to a content distribution network.

Another object of the present invention is to provide recorded video and audio data to users for translation of the video and audio data.

A still further object of the present invention is to provide live video and audio data to users that allows message data to be received and displayed with the video and audio data.

These and other objects are met by the present invention which in one aspect can be a network system for providing live video based discussion comprising: a host server for connecting with a plurality of browser clients; a web site having an embedded code that allows a connection between said host server and each of said plurality of browser clients; a media server for receiving first live video and audio data from a first individual browser client and second live video and audio data from a second individual browser client; wherein said host server receives instructions from individual browser clients requesting said first and second live video and audio data and said host server requests said media server to rout said live video and audio data to each individual browser client that requests said live video and audio data; wherein said media server connects with said individual browser client that requests said first and second live video and audio data and streams said first and second live video and audio data to said individual browser client that requests said first and second live video and audio data; and a customized flash video player in each of said plurality of browser clients for receiving said first and second live video and audio data, wherein said first and second live video and audio data are continuously synchronized by said customized flash video player.

In another aspect the invention can be a network system for providing live video based discussion to a content delivery network comprising: a host server for connecting with a plurality of browser clients and with a content delivery network; a web site having an embedded code that allows a connection between said host server and each of said plurality of browser clients; a data server connected to said host server, said data server receiving message data from said plurality of browser clients; a media server connected to said host server, the media server receiving live video and audio data from at least one of said plurality of browser clients; and wherein said host server receives said live video and audio data from said media server and said message data from said data server, said host server streaming said live video and audio data and said message data to said content delivery network.

In a further aspect the invention can be a network system for providing live video based discussion comprising: a host server for connecting with a plurality of browser clients; a web site having an embedded code that allows a connection between said host server and each of said plurality of browser clients; a media server for receiving first live video and audio data and second live video and audio data from individual browser clients, said media server having a memory; said media server storing said first and second live video and audio data in said memory as first and second stored video and audio data; wherein said host server receives instructions from individual browser clients requesting said first and second stored video and audio data and said host server requests said media server to rout said first and second stored video and audio data to each individual browser client that requests said first and second stored video and audio data; wherein said media server connects with said individual browser client that requests said video and audio data and streams said first and second stored video and audio data to said individual browser client that requests said stored video and audio data; wherein said streamed first and second video and audio data is continuously synchronized by said media server; and a customized flash video player in each of the plurality of browser clients for receiving said synchronized video and audio data.

In another aspect the invention can be a method A method for providing live video based discussion via a network comprising: providing a host server for connecting with a plurality of browser clients; providing a web site having an embedded code that allows a connection between said host server and each of said plurality of browser clients; connecting said host server with said plurality of clients; providing a media server for receiving first live video and audio data from a first individual browser client and second live video and audio data from a second individual browser client; sending a first live video and audio data from a first individual browser client and second live video and audio data from a second individual browser client to said media server; sending instructions to said host server from individual browser clients requesting said first and second live video and audio data; said host server requesting said media server to rout said live video and audio data to each individual browser client that requests said live video and audio data; connecting said individual browser client that requests said first and second live video and audio data to said media server and streaming said first and second live video and audio data to said individual browser client that requests said first and second live video and audio data; and providing a customized flash video player in each of said plurality of browser clients for receiving said first and second live video and audio data, wherein said first and second live video and audio data are continuously synchronized by said customized flash video player.

In another aspect the invention can be a method of synchronizing two video streams on a client computer comprising: time-stamping a first video and audio stream; time-stamping a second video and audio stream; measuring a time difference between said first video and audio stream; slowing down said first video and audio stream where the time difference exceeds a predetermined value.

### BRIEF DESCRIPTION OF DRAWINGS

FIG. 1 is a block diagram of a network system for providing live video based discussion according to one embodiment of the present invention.

FIG. 2 is an illustration of a page of an affiliate website according to one embodiment of the present invention.

FIG. 3 is an illustration of a page of an affiliate website according to another embodiment of the present invention.

FIG. 4 is an illustration of a view window with a discussion list according to one embodiment of the present invention.

FIG. 5 is an illustration of a discussion parameters section according to one embodiment of the present invention.

FIG. 6 is an illustration of a discussion window according to one embodiment of the present invention.

FIG. 7 is an illustration of the discussion window of FIG. 6 with two participants according to one embodiment of the present invention.

FIG. 8 is an illustration of the discussion window of FIG. 6 with four participants according to one embodiment of the present invention.

FIG. 9 is an illustration of the discussion window of FIG. 8 after the start discussion link has been selected according to one embodiment of the present invention.

FIG. 10 is an illustration of a discussion window showing a live discussion according to one embodiment of the present invention.

FIG. 11 is an illustration of window for joining a discussion according to one embodiment of the present invention.

FIG. 12 is an illustration of a discussion room according to one embodiment of the present invention.

FIG. 13 is an illustration of the discussion room of FIG. 12 showing a results window according to one embodiment of the present invention.

FIG. 14 is an illustration of a window showing a recorded video discussion according to one embodiment of the present invention.

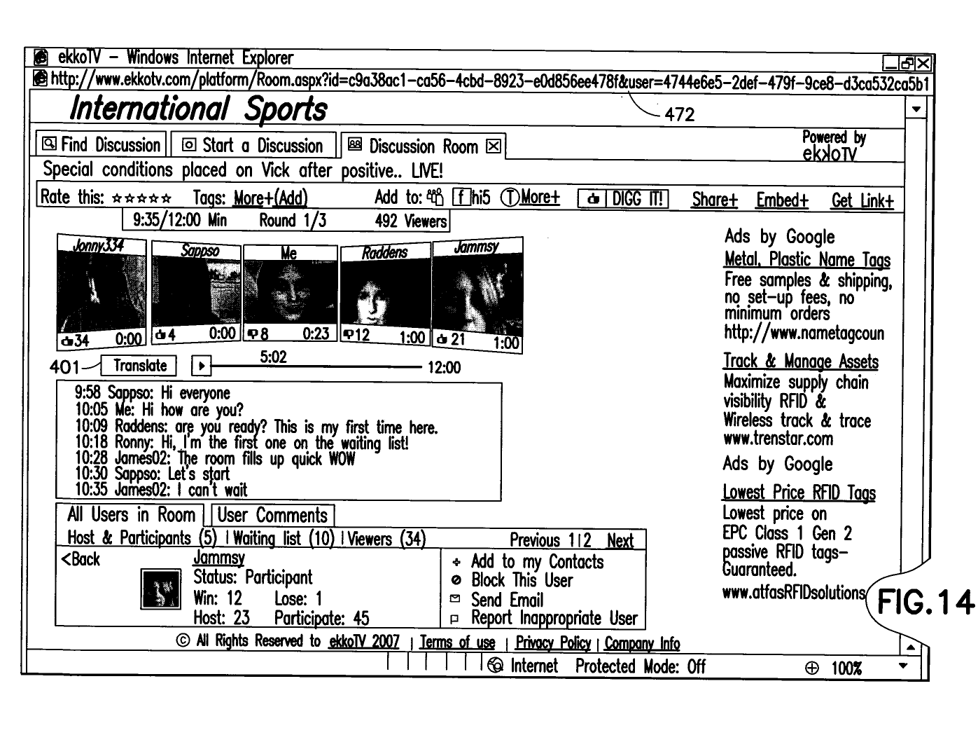

FIG. 15 is an illustration of the window of FIG. 14 with a translate discussion option window according to one embodiment of the present invention.

FIG. 16 is an illustration of the window of FIG. 14 with a language drop-down menu according to one embodiment of the present invention.

FIG. 17 is an illustration of the window of FIG. 14 with a text field according to one embodiment of the present invention.

FIG. 18 is an illustration of a discussion window showing the synchronization of three video streams according to one embodiment of the present invention.

FIG. 19 is am illustration of a network system connected with a content distribution network according to one embodiment of the present invention.

### DETAILED DESCRIPTION OF THE DRAWINGS

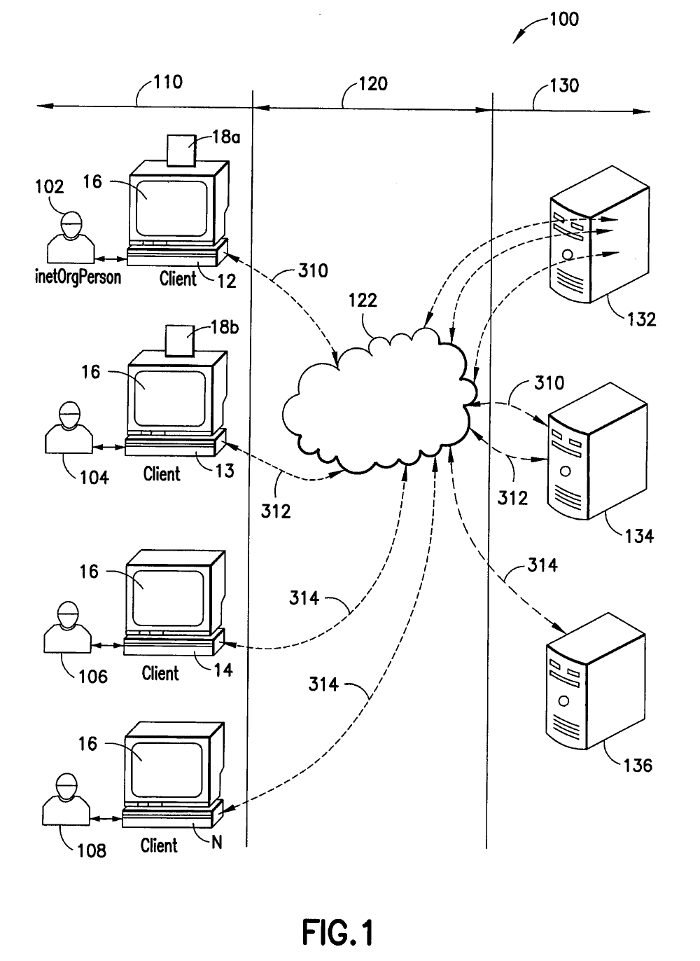

Referring to FIG. 1, there is illustrated a diagram of a network system 100 for providing live video based discussion. The video based discussion is a hosted solution that can be provided to an owner of any sized website to add real-time, live video discussion capability to their website. As will be discussed in further detail below, all functionality, storage and content distribution are done by a host server 132, and are supplied to a browser client (individual client) 102, 104, 106, 108 connected to the client website. The video based discussion allows the individuals clients 102, 104, 106, 108 to discuss and/or view discussions of a variety of events that are important to them via a network 122, such as the internet. There are generally two types of clients that use the network system 100 for live video based discussion. The first type of individual clients are those that can participate in the discussions and they may sometimes be referred to as participant clients 102, 104. The second type of clients are those that can view the discussions, send text messages and vote on the discussions, and they will be referred to as viewing clients 106, 108. The participant clients 102, 104 can participate in live video discussions or watch recorded video discussions from any location on the globe. The viewing clients 106, 108 can view live or recorded video discussions can also send text comments and vote as well send other data to all clients in real time.

The network system 100 comprises a client side 110, a communications interface 120 and a server side 130. The client side 110 comprises four client computers illustrated as a client computer 12, a client computer 13, a client computer 14, and a client computer N. It is to be understood however, that the client side 110 does not require four client computers and is not limited to four client computers, but rather could be any number of client computers. Only four client computers 12, 13, 14, N are shown for the sake of clarity of the figures. The communications interface 120 includes a web server 124 and a network 122 which is a Wide Area Network, like the internet. The invention is not so limited however, and the network 122 could be a local area network (LAN) and the like. The server side 130 comprises a host server 132, a media server 134, and a data server 136. The client computers are connected to the web server 124 via the network 122.

Each client computer 12, 13, 14, N, includes a display screen 16 as well as other computer system components well known in the art such as hard disk drive, memory bus, random access memory, read only memory, network interface, keyboard and disk drive. The type of computer is not limiting of this invention and client computers 12, 13, 14, N can be any personal computer such as an Apple computer, an IBM computer or one of the compatibles thereof, a workstation computer, or some other type of computer. Additionally, client computers 12, 13, 14, N do not have to be the same as each other. Client computers 12, 13, 14, N connect to a network 122 to send and receive data over the network 112 which is connected to other computer systems. An interface card (not illustrated) can be used to connect the client computers 12, 13, 14, N to the network 122 and transfer data according to standard protocols. Client computers 12 and 13 also have a video camera 18 for receiving video and audio data from the participating clients 102, 104. The invention is not so limited however and all of the client computers 12, 13, 14, N, or only one of the client computers may have a video camera 18, but two client computers 12, 13 having camera 18 were chosen for exemplary purposes only.

Although illustrated as three separate systems, the host server 132, the video server 134 and the data server 136 could all be implemented on one system. The servers 132, 134, 136 may be directly connected with each other to allow for faster communications and data transfer between them.

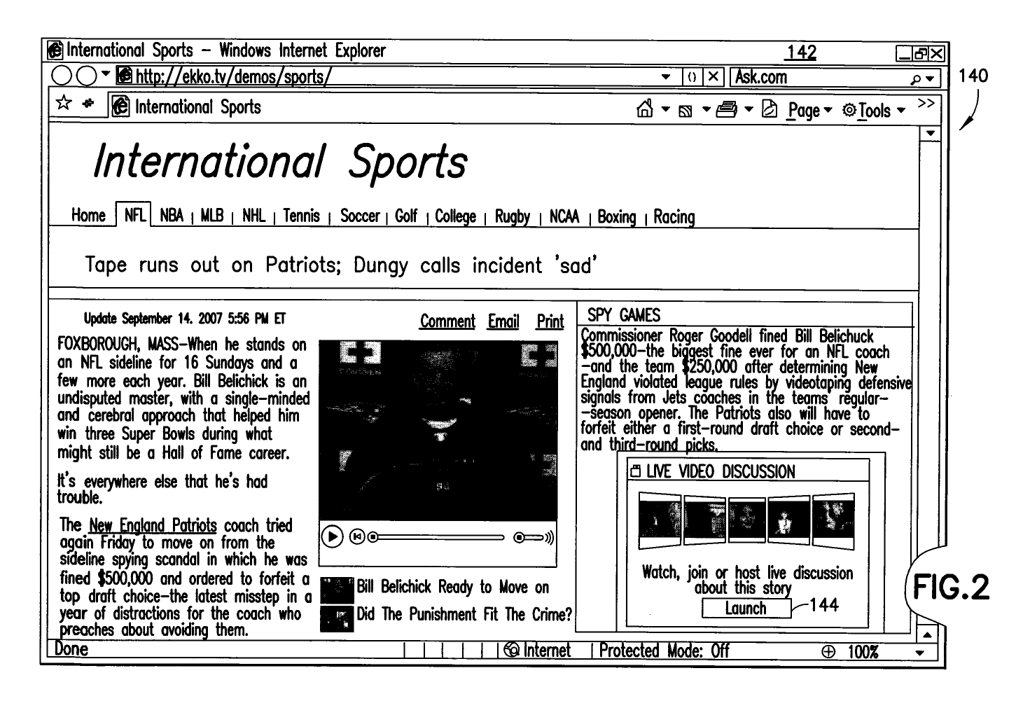

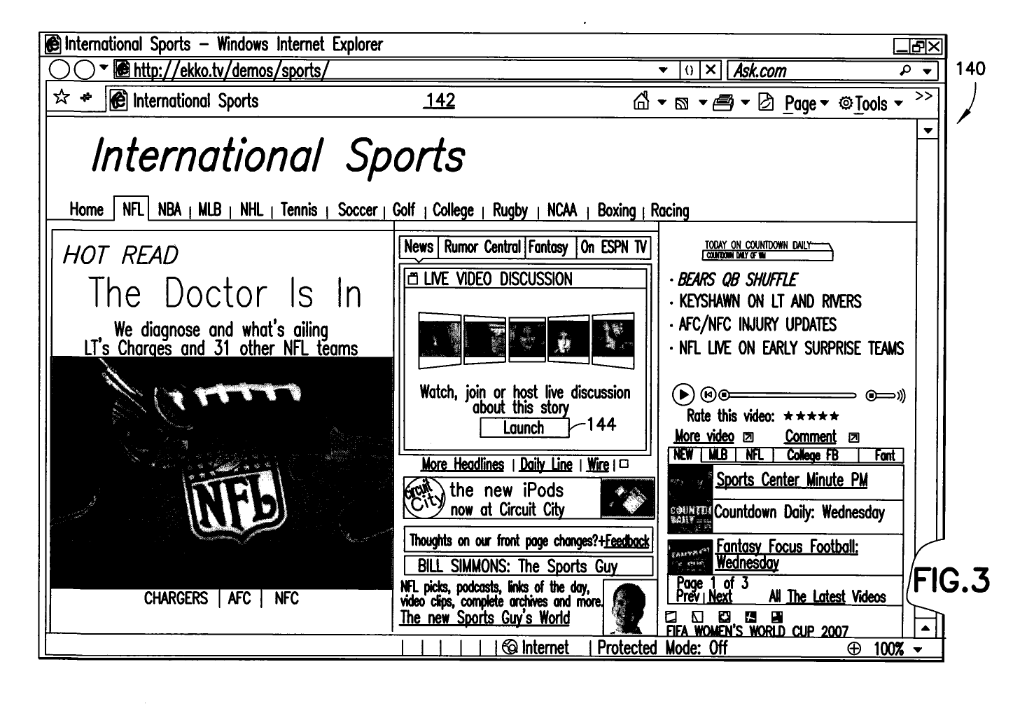

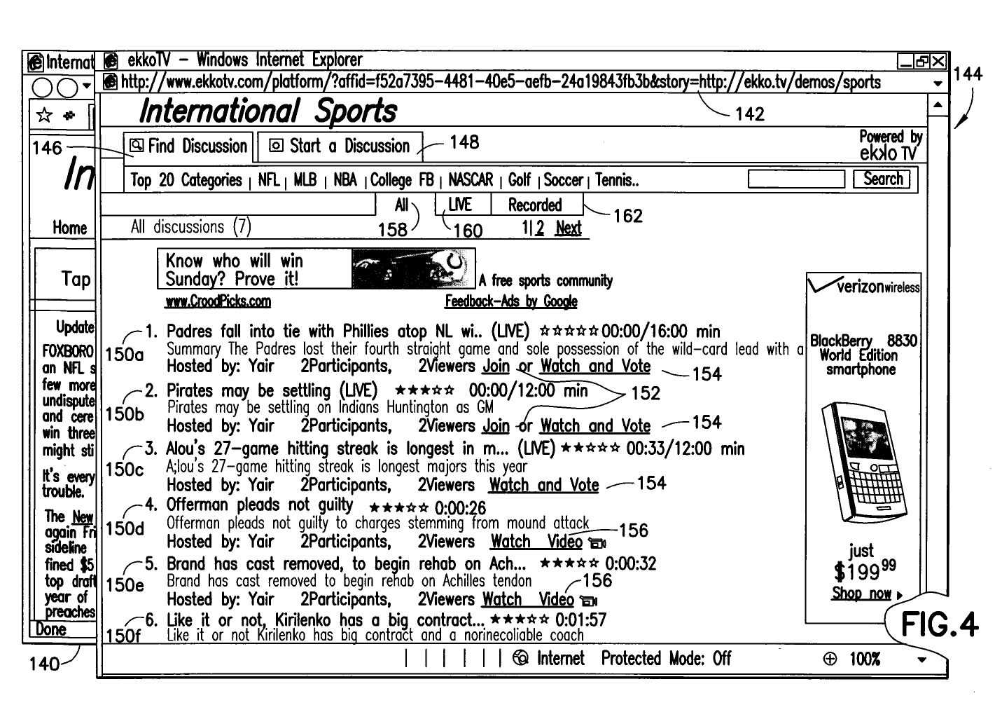

The interaction between individual clients 102, 104, 106, 108 using client computers 12, 13, 14, N and the host server 132, video server 134 and data server 136 will now be discussed. Referring to FIGS. 1 and 2, an individual browser client 102, 104, 106, 108 visits an affiliate website 140 having a discussion enabled page 142. The affiliate website can be any website. The discussion enabled page 142 includes a launch button 144. The launch button 144 is a link that results in the browser encountering code that launches a video window 144 (shown in FIG. 4). In this FIG. 2, the launch button 144 is located in a specific story on the website 140. Alternatively, as shown in FIG. 3, the launch button 144 could be anywhere on the affiliate website 140 and not in a specific story. The discussion enabled page 142 is created by incorporating the following exemplary code which creates the launch button 144 into the affiliate website 140 code. In order to insert the launch button 144 the host server 132 inserts embedded code that was copied from the specific affiliate website 140. The host server 132 wraps the launch button 140 with the embed code as follows: <h3><img

src=“images/live_discussion_icon.gif” alt=“live video discussion powered by ekkoTV”
width=“20” height=“19” align=“absmiddle” />LIVE VIDEO DISCUSSION</h3>

<div class=“lined”>
<p><img src=“images/ekkotv_app.gif” alt=“ekkoTV” width=“286” height=“94” /></p>
<span class=“smalltext”>Watch, join or host live discussion about this story. <br />
</span> <br />
<a href=“javascript:void(0);”

onclick=“javascript:window.open(‘http://www.ekkotv.com/platform/?affid=f52a7395-4481-
40e5-aefb-24a19843fb3b&story=’ + document.URL, ‘DescussionWindow’, ‘width=888,
height=650, scrollbars=1’);“><img src=“images/button-launch-normal.jpg” alt=“launch button”
name=“launch_button” width=“111” height=“24” border=“0” id=“launch_button”
onmouseover=“MM_swapImage(‘launch_button’,″,‘images/button-launch-over.jpg’,1)”
onmouseout=“MM_swapImgRestore( )” /></a><br />

<br />

</div>

The code is for exemplary purposes only, and the invention is not so limited so long as a button creating a link to the host server 132 is created in the affiliate webpage 140.

As will be discussed in further detail below, the host server 132 connects with a plurality of browser clients also referred to as individual clients 102, 104, 106, 108 through their use of the client computers 12, 13, 14, N which are connected to the network 122. The individual clients 102, 104, 106, 108 visit the affiliate website 140 which has the embedded code shown above that allows a connection between the host server 132 and each of the individual clients/browser clients 102, 104, 106, 108. As will be discussed in further detail below, when the individual clients choose to join a discussion via a join link, the media server 134 receives first live video and audio data 310 from a first individual browser client 102 and second live video and audio data 312 from a second individual browser client 104. The media server 134 can perform simultaneous delivery and playback, or streaming, of video. Video may be captured and encoded for real-time communication, or it may be pre-encoded and stored for later viewing. The video and audio data 310, 312 is recorded by the video cameras 18 and the client computers 12, 13 will transmit the live video and audio data 310, 312 to the media server 132 via the network 122. Additionally, the host server 132 receives instructions requesting the first and second live video and audio data 310, 312 and/or sending message data 314 from individual browser clients 106, 108 that choose to watch a discussion via selecting the watch link. The host server 132 requests the media server 134 to rout the live video and audio data 310, 312 to each individual browser client 106, 108 that requests the live video and audio data 310, 312 and to the participating browser clients 102, 104. The media server 134 connects with the individual browser clients 106, 108 that requests said first and second live video and audio data 310, 312 and with the participating browser clients 102, 104. The media server streams the first and second live video and audio data 310, 312 to the individual browser client 106, 108 and to the participating browser clients 102, 104. The client computers 12, 13, 14, N each include a customized flash video player in each for receiving the live video and audio data 310, 312. The customized flash video player will continuously synchronize the live video and audio data 310, 312, as will be discussed in more detail below.

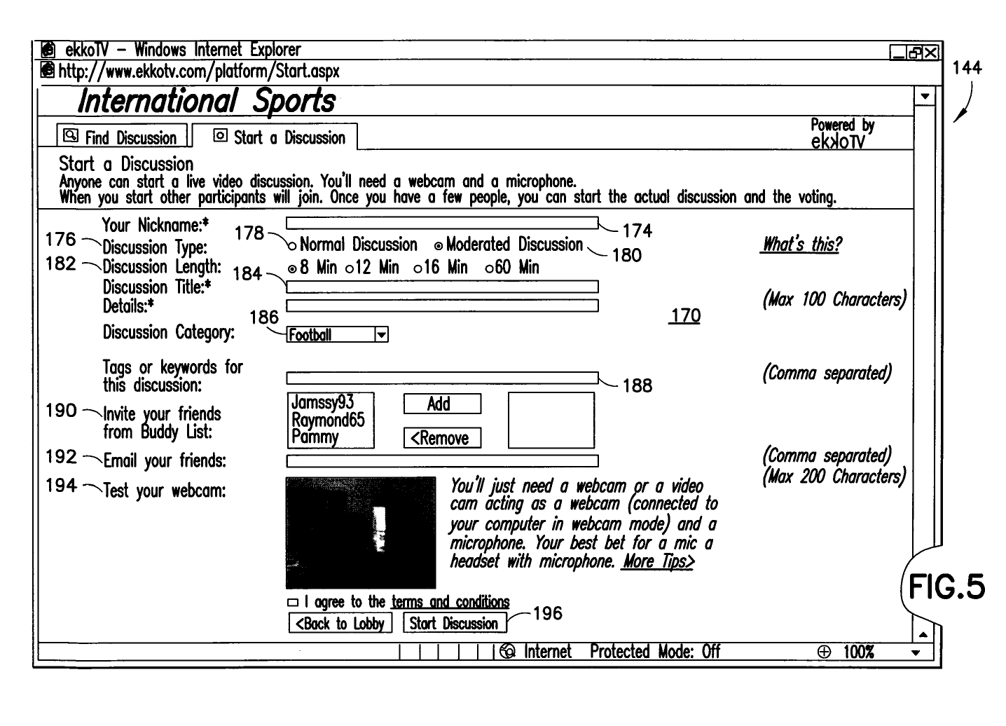

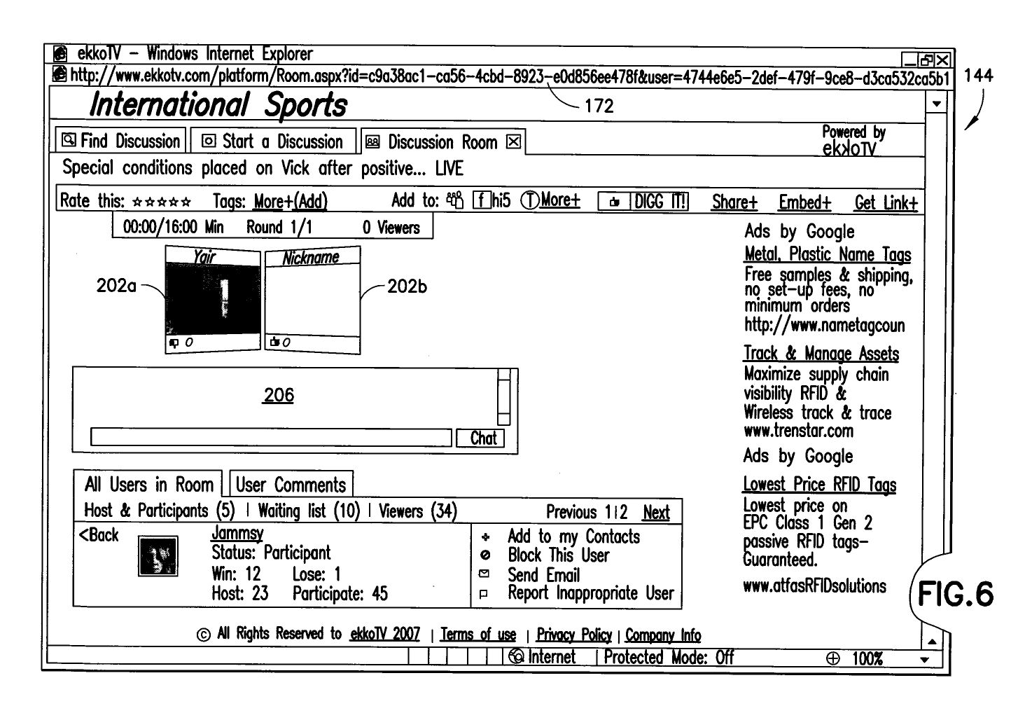

Referring now to FIGS. 1 and 4, a video window 144 which pops up in the display 16 of the client computer 12, 13, 14, N is illustrated which allows the individual client 102, 104, 106, 108 to select a discussion video (e.g. video and audio data 310, 312). The decorative format of video window 144 is for exemplary purposes only and is not limiting of the invention. All communication in the video window 144 is between the client computer 12, 13, 14, N and the host server 132 as discussed above with reference to FIG. 1. The video window 144, also referred to as a discussion lobby, lists all the discussions 150 a-e that are related to the specific story from the affiliate website 140 that the launch button 144 was connected to. The video window 144 comprises a find discussion tab 146 and a start a discussion tab 148. The find discussion tab 146 is where the list of discussions 150a-e are illustrated. There are three types of discussions 150a-f, which are live, recorded and in-progress. The in-progress discussions 150a-c allow the individual clients 102, 104, 106, 108 to watch and vote by selecting the watch and vote link 154. By selecting the watch and vote link 154 a live discussion will be streamed to the individual client that selected the watch and vote link, as discussed in greater detail below. If an in-progress discussion is an open in-progress discussion 150 a-b, then an individual client 102, 104 with a computer system 12, 13 having a camera 18a-b may participate in the discussion by selecting the join link 152. When one of the individual clients 102, 104 selects the join link 152, that client may stream video and audio to the host server 132, as will be discussed in further detail below. The recorded discussions 150d-e allow an individual client 102, 104, 106, 108 to watch a the selected recorded discussion when the individual client selects the watch video link 156. The video window 144 further comprises the live tab 160 and the recorded tab 162. Selecting the live tab will cause to be displayed only open in-progress discussions 150 a-b and the recorded tab will display only the recorded discussions 150 d-e. Selecting the start a discussion tab 148 will show discussion parameters section 170 (shown in FIG. 5) which gives the individual client 102,104, 106,108 the ability to create a discussion room 172 (shown in FIG. 6) for a set number of participating clients 102, 104.

Referring now to FIGS. 1 and 5, the discussion parameters section 170 is illustrated. The aesthetic aspects of the discussion parameters section 170 of the video window 144 are not limiting of this invention. A individual client 102, 104, 106, 108 who creates a discussion room 172 (shown in FIG. 6) will also be referred to as a room manager. The discussion parameters section 170 comprises a nickname field 174. The room manager generally must have a nickname in order to start a discussion. A discussion type section 176 allows the room manager to choose between normal mode 178 and moderated mode 180. If moderated mode 180 is selected, then the user will be the moderator. If normal mode 178 is selected then regimented rounds of discussion, as will be discussed in further detail below, will be used. A discussion duration section 182 allows the room manager to select a length of the video discussion. The selections in the illustrated embodiment are 8, 12, 16 and 60 minutes. The invention is not so limited however, and various other duration selections may be presented. The discussion duration section 182 is available only if moderated mode 180 is selected. A discussion title field 184 requires the room manager to insert a title for the video discussion. The title that the room manager inserts into the discussion title field will be used as the title in the discussion lobby/video window 144. A discussion category dropdown menu 186 allows the room manager to associate the discussion with a specific category. A tags field 188 allows the room manager to add tags which will allow other people to search this discussion. An invite friends menu 190 allows the room manager to select friends from a list that he created. An email field 192 provides the room manager the ability to send an email to friends not included in the list in the friends menu 190. A webcam test link 194 allows the room manager to see a displayed video 198 of himself and ensure his video camera 18 is functioning. The invention is not limited to the fields and menus discussed above, and other fields and/or menus or less fields and/or menus may be included in the discussion parameters section 170. A start discussion link 196 allows the room manager to go to a discussion room 172 (shown in FIG. 6) that includes all of the data that he entered and selected in the discussion parameters section 170.

Referring now to FIG. 6, an exemplary discussion room 172 is illustrated. The invention is not limited to any particular layout and/or format of discussion room 172. The default number of participating clients 102, 104 in a video discussion is five. The invention is not so limited however, and the default can be changed to allow more people to participate. A individual client 102, 104, 106, 108 who creates a discussion room 172 (the room manager), is not required to set the number of participants in advance of creating the discussion room 172. All discussion rooms 172 are created with five open seats as default. The room manager can choose when to start a live video discussion which automatically sets the number of allowed participants. For example a room manager creates a discussion room 172 to discuss a particular topic of interest as discussed above with reference to FIG. 5. The discussion room 172 can include up to 5 participating clients by default. The discussion room 172 initially comprises two video frames 202a, 202b. The room manager can be viewed in video frame 202a.

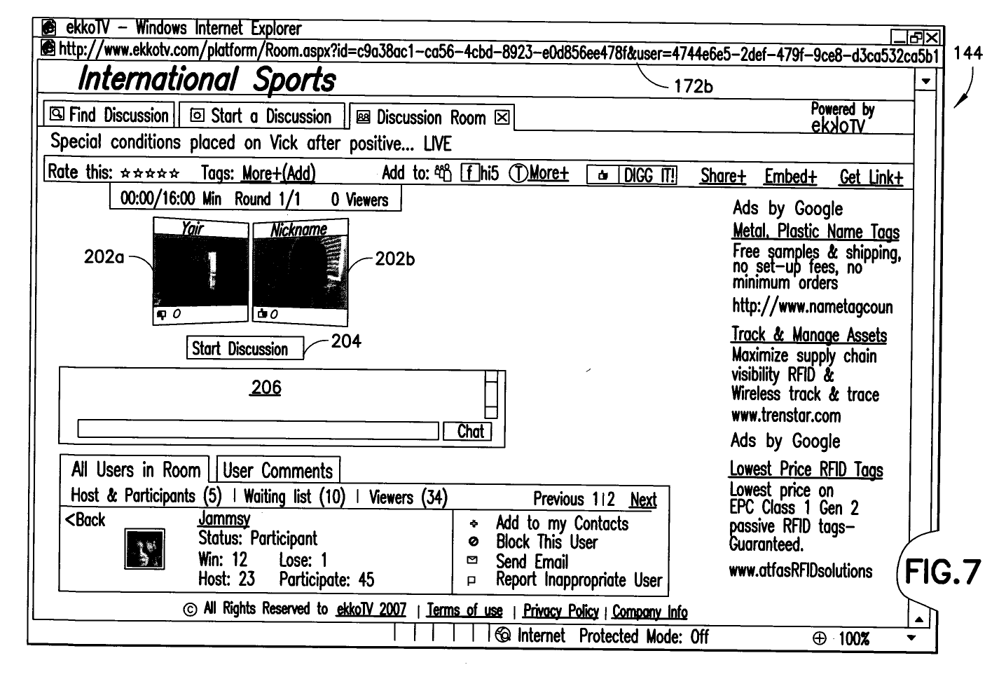

Referring now to FIG. 7, discussion room 172b is illustrated. Discussion room 172 b is the same as discussion room 172 except that a participant has joined the discussion by selecting the join link 152 (shown in FIG. 4). The participant is for example an individual client 102, 104 with a video camera 18 (shown in FIG. 1). The first participant is visible in video frame 202b. A start discussion link 204 (visible only to the room manager) will now become available because a first participant has joined the discussion room 172b. The room manager and the first participant can also chat via the chat window 206. The room manager and the first participant may transmit message data through their computer systems 12, 13 and to the host server 132 which will then collect the message data and transmit the data to the client computers 12, 13 and any other computers that may me viewing the discussion without participating such as computer systems 14, N.

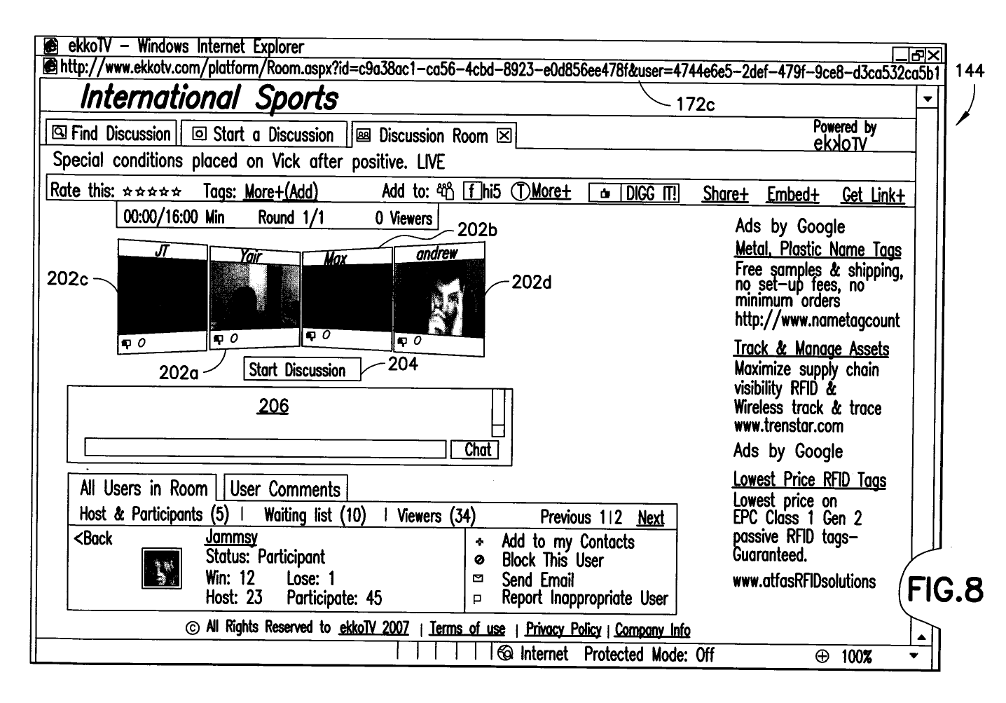

Referring now to FIG. 8, the discussion room 172c having a second and a third participant is illustrated. After the discussion room 172c is created by the room manager, three participating clients/individual clients 102, 104 join the created discussion by selecting the join link 152 (shown in FIG. 4) that is associated with the story of interest for which the room manager created the discussion room 172. All of the participants and the room manager are shown in the video frames 202a-d. The room manager may select the start discussion link 204 or wait for a fourth participant to join the discussion. If a fourth participant joins the discussion, then the default number of participants (five including the room manager) are in the discussion room 172 and the discussion will automatically begin. Alternatively, the room manager may select the start discussion link 204 when less than the four participants have joined the discussion.

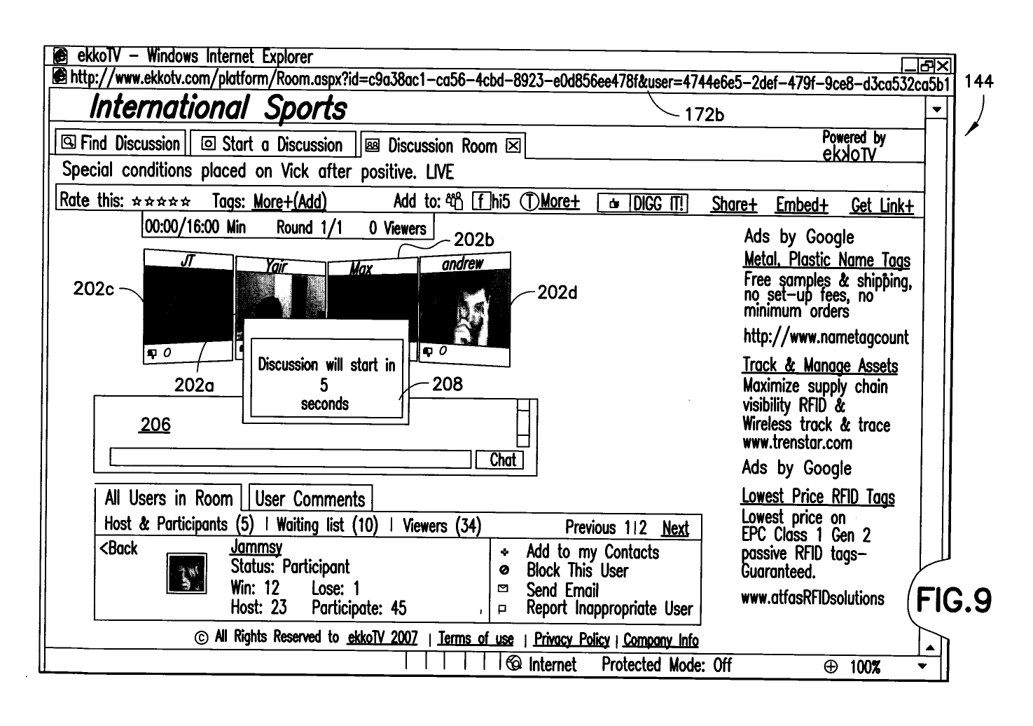

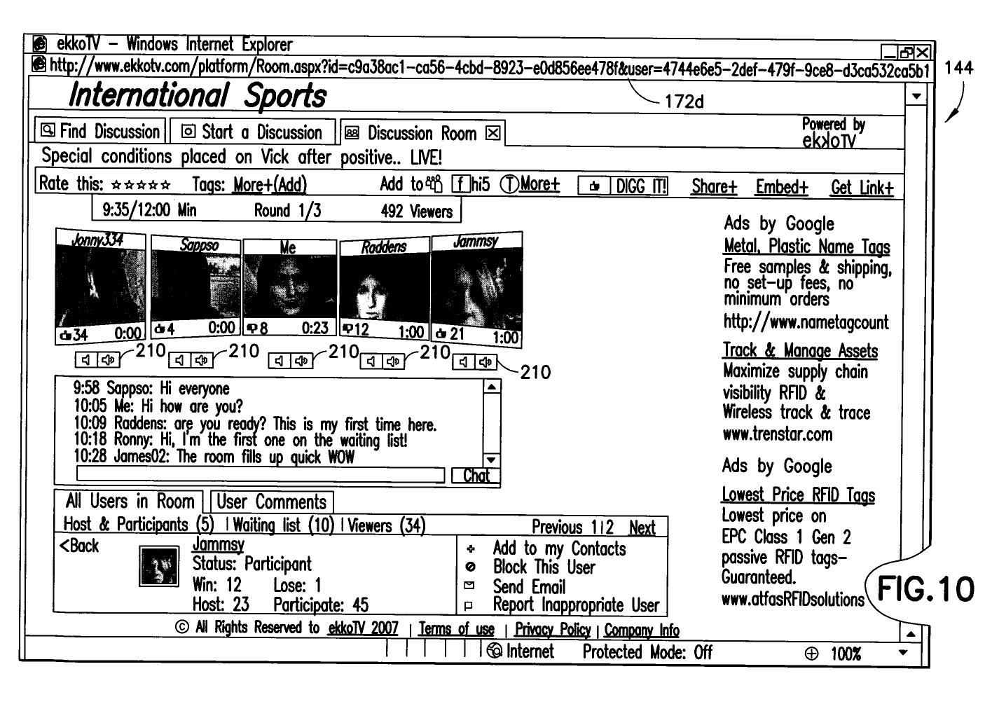

Referring now to FIG. 9, the discussion room 172c is illustrated as it would appear immediately after the room manager selected the start discussion link 204. When the room manager decides to starts the discussion by selecting the start discussion link 204 (that is available only to him), the discussion room 172 is then limited to the four participants currently sending video data to the host server 132. A display message 206 is shown to all individual clients 102, 104, 106, 108, and others viewing the video discussion via client computers N when the room manager selects the start discussion link 204. Additionally, the host server 132 starts recording the video and audio data from participating individual clients 102, 104 as well as the chat data from individual clients 106, 108 and others viewing the live discussion via client computers N. Before the room moderator selects the start discussion link 204, all microphones 210 (shown in FIG. 10) are in open mode. Where normal discussion mode 178 was selected from the discussion type section 176 (shown in FIG. 5), regimented rounds of discussion will begin.

Referring now to FIGS. 1 and 10, concurrently, a discussion room 172d having five participants (including the room manager) is illustrated. Where a moderated discussion was selected, the room manager's microphone 210 will be open first so that the manager will speak first. Where normal mode discussion was selected, the media server will start rounds. The room manager will speak first and the other participant will speak in consecutive order from left to right for a predetermined amount of time.

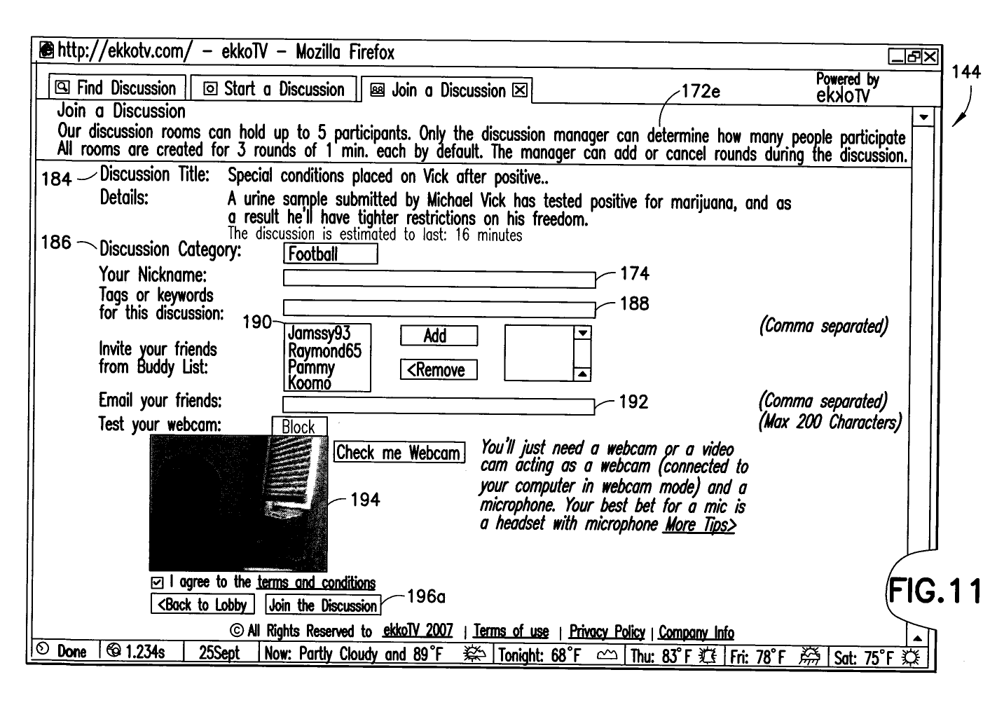

Referring now to FIGS. 1 and 11, the interaction between an individual client 102, 104 that requests to join a discussion will now be discussed. The join discussion window 172e is illustrated in FIG. 11. Where one of the individual clients 102 selects the join link 152 (shown in FIG. 4) that client may send video and audio data 310 to the host server 132. Upon selecting the join link 152, the join discussion window 172e is open in the client's website 144. The discussion title field 184 and the category 186 is already populated with the values entered and selected by the discussion manager (discussed with reference to FIG. 5). Where the individual client 102 selects the join discussion button 196a he is sent to the discussion room 170 (shown in FIG. 8).

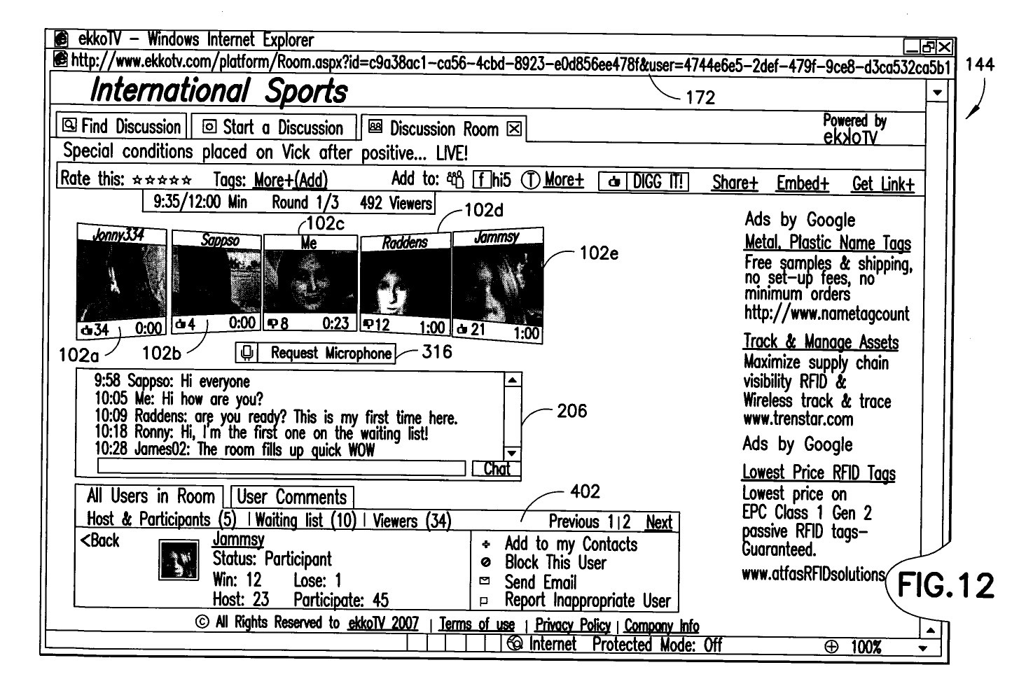

Referring now to FIGS. 1 and 12, a discussion room 172 with a video discussion in progress is illustrated. The five participant clients 102a-c are shown in the five video frames 202a-e. Each participant client 102a-e is utilizing a client computer like client computers 12, 13 shown in FIG. 1. The client computers 12, 13 are connected to the host server 132, the media server 134 and the data server 136 via the network 122. The participants clients 102a-e are sending video and audio data to the media server 134 via their cameras 18 and message data to the data server 136. As shown in viewer count display 402, there are also thirty-four (34) viewing clients 106, 108 connected to the servers 132, 134, 136. The viewing clients may use client computers 14, N that do not have cameras 18 or client computers 12, 13 that do have cameras, however the viewing clients do not transmit video and audio data rather the viewing clients can send message data 314 to the data server 136 such as votes, text messages and the like that are shown to all clients via the chat window. The participant clients 102 a-e also see a request microphone button 316 for participants in the moderated mode discussion only when their microphone is muted by the discussion manager. Selecting the request microphone button 316 will trigger a microphone icon (not illustrated) in the discussion manager's window.

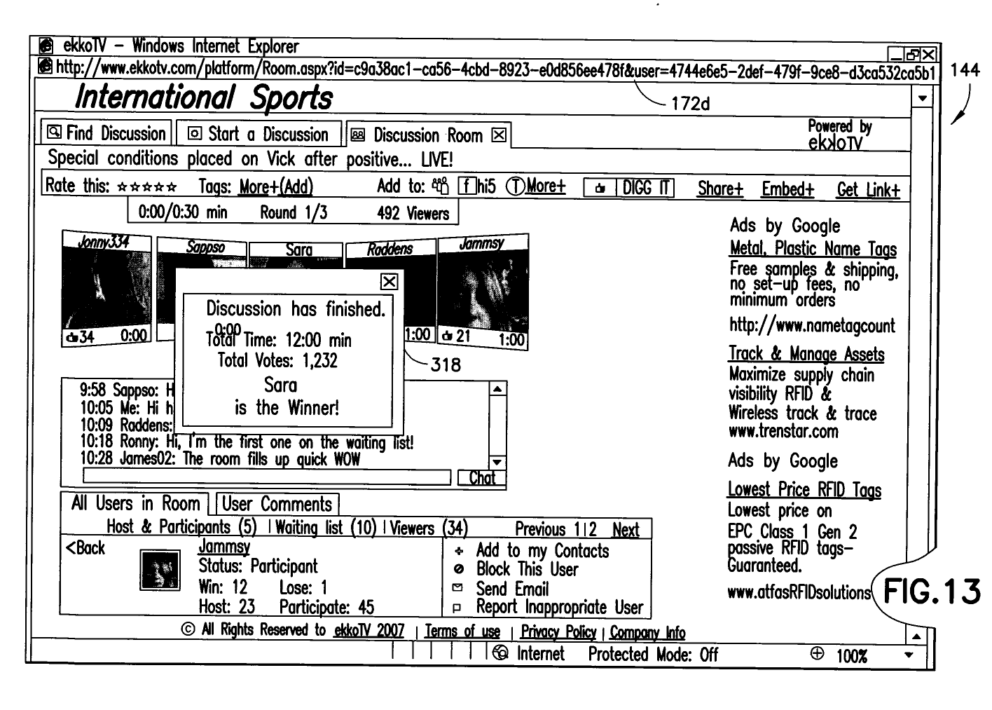

Referring now to FIG. 13, a discussion room 172d is illustrated which shows the end of a live discussion video. At the end of a moderated or normal discussion, a results window 318 is displayed which shows the total length of the discussion, the total votes received from the viewing clients and which participant received the highest number of votes. The data that is displayed in the results window is data that is received and managed by any one of the servers 132, 134, 136. After the results window 318 is displayed, the winning participant may be given additional time with an open microphone to give closing remarks The additional time may be 30 seconds or any length of time.

Upon a live discussion being completed, the recorded version of the live discussion is available for viewing from the webpage 144. The chat and voting features are disabled, thus the viewing participant cannot send data 314 to the servers 132, 134, 136. The viewing client however can play or pause the video or move forwards and backwards using a video slider.

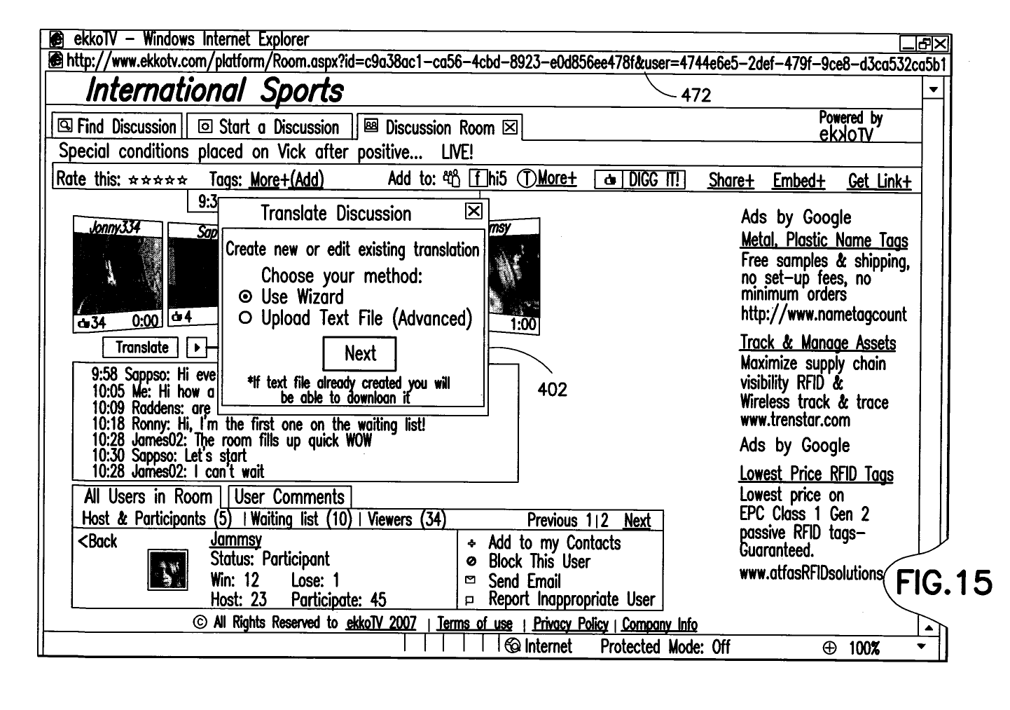

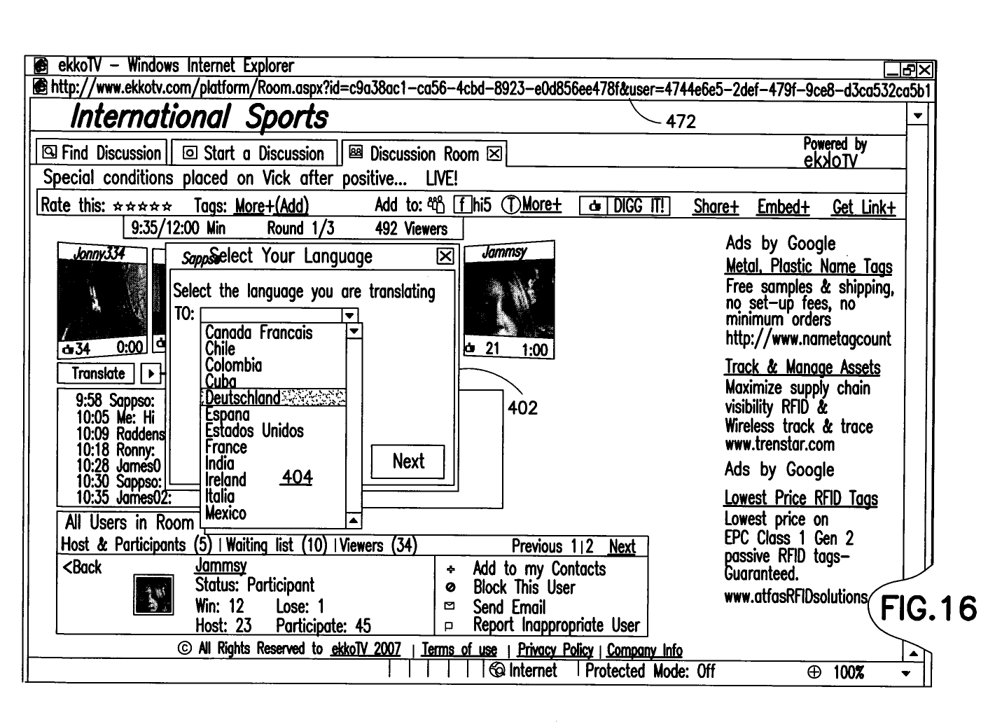

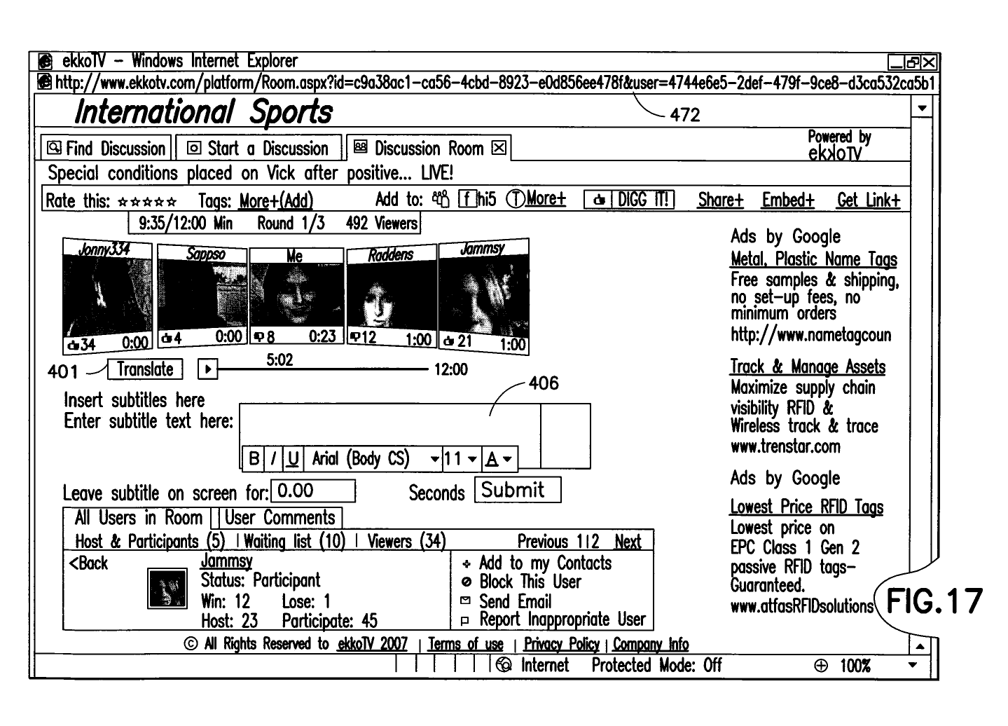

Referring now to FIGS. 15-17, a window 472 showing a recorded discussion video is illustrated. The window 472 is the same as discussion window 172 discussed above, therefore only the differences between discussion window 172 and window 472 will be discussed. Window 472 includes a translate request button 401 so that the recorded discussion video may also be translated by clients 102, 104, 106, 108. when a client 102, 104, 106, 108 selects the translate request button, the host server receives a translation request for the recorded video and audio data. The host server 132 then sends the translation request to all of the browser clients. When a browser client wants to translate the recorded video, he can add a text file having caption segments comprising a timecode, caption text and a blank line to the stored video and audio data. Alternatively, the browser client can use a translation wizard from the host server 132. Both options are available via a translate discussion window 402. The browser client that is translating the recorded video will select a language to which he is translating from a drop-down menu 404. The field 406 for inserting the translation text is shown in FIG. 17.

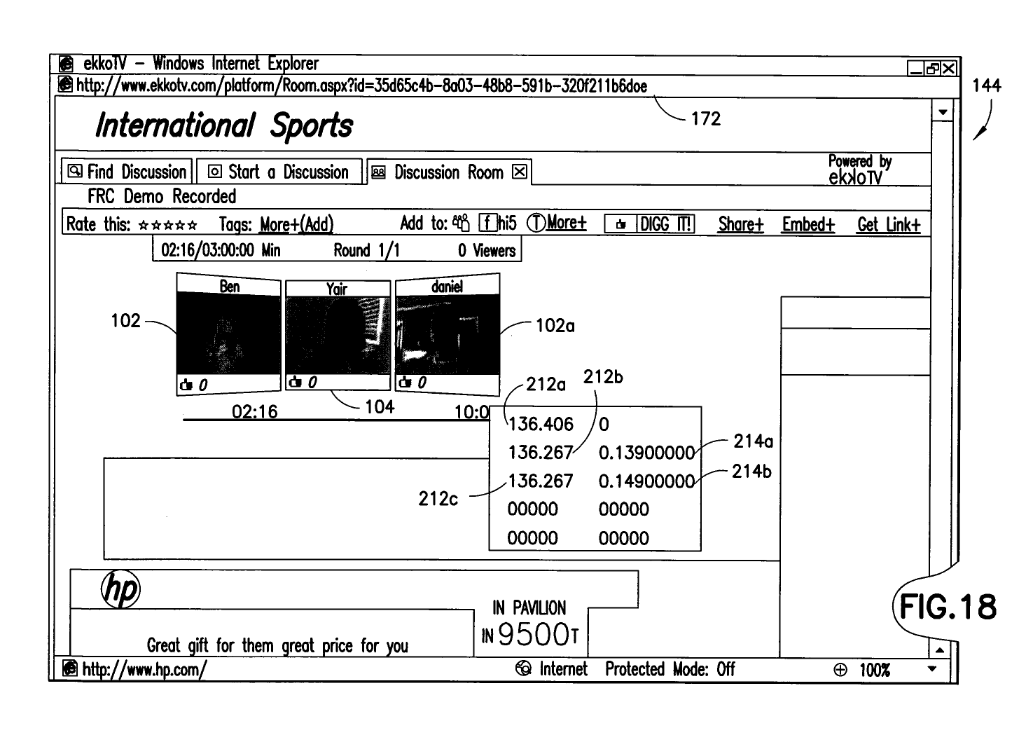

Referring now to FIGS. 1 and 18, the synchronization method of the flash video player in each client computer 12, 13, 14, N will now be discussed. Where an individual client, for example client 108 in FIG. 1, has requested to view a live discussion having three participants 102, 104, 102b (only two participants 102, 104 are shown in FIG. 1 but three are shown in FIG. 11). The five participants 102a-d are sending video and audio data 310, 312, etc. (only two are illustrated in FIG. 1 but in this discussion five video and audio data are being transmitted through the network 122) to the media server 132. The media server 132 will divide each of the five live video and audio data into a first through third set of video and audio frames. The media server 132 will then mark each of the first through fifth set of video and audio frames with a time stamp 212a, 212b, 212c. As the streams are being played in the client computer N, they are comparing themselves to each other. More specifically, the first video and audio stream will get a first timestamp 212a, the second video and audio stream will get a second timestamp 212b and the third video and audio stream will get a third timestamp 212c, and so forth for video discussions having more participants. The customized flash video player in the client computer N continuously synchronizes the video and audio streams by measuring a time difference between the timestamps 212a, 212b, 212c at set intervals of about ¼ of a second. On stream, in this case the moderator stream is the reference stream. The other two streams are compared against the moderator stream. If the time difference 214a between the second stream and the reference stream or the time difference 214b between the third stream and the reference stream exceeds a predetermined amount, for example 0.25 then the customized flash media player in the client computer N will slow down the fast stream. In a recorded video discussion (not live video discussion) the customized flash media player will speed up a slow stream. More specifically, in recorded sessions, all streams are being downloaded via a progressive download and cached in the clients computers N. The customized flash player starts playing the streams only after at least 10% of the total of each of the streams has been downloaded. Then all streams are played side by side at the same time. The time stamps are compared in the same way as discussed above. Where a difference greater than a predetermined amount, is measured by the media server 134, the media server 134 or the customized flash video player speeds up the transmission rate or play rate of the slower video stream.

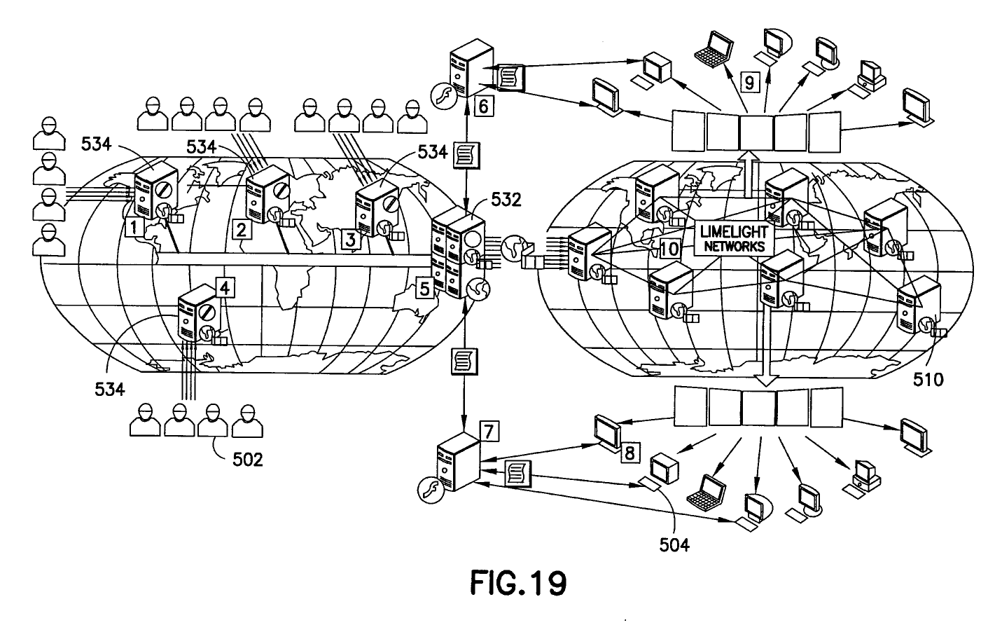

Referring now to FIG. 19, the a network system for providing live video based discussion to a content delivery network 510 is illustrated. The network system comprises a host servers 532 for connecting with a plurality of browser clients 502, 504 and with the content delivery network 510. Each browser client 502 is connected to a web site having an embedded code that allows a connection between the host server 532 and each of the browser clients 502 as discussed above with reference to FIGS. 1-3. Two data servers 6,7 are connected to the host server 532. The data servers 6,7 receives message data from the browser clients 504. Four media servers 534 are connected to the host server 532. The media servers 534 also receives live video and audio data from at least one of the browser clients 502. The host server 532 receives the live video and audio data from the media servers 534 and the message data from the data s 6,7. The host server 532 then streams the live video and audio data and the message data to the content delivery network (CDN) 510. The CDN 510 improves end-user performance by caching popular content on edge servers located closer to users. This provides a number of advantages. First, it helps prevent server overload, since the replicated content can be delivered to users from edge servers. Furthermore, since content is delivered from the closest edge server and not from the origin server, the content is sent over a shorter network path, thus reducing the request response time, the probability of packet loss, and the total network resource usage. While CDNs were originally intended for static web content, recently, they are being designed for delivery of streaming media as well.

The foregoing description of the preferred embodiment of the invention has been presented for the purpose of illustration and description. It is not intended to be exhaustive or to limit the invention to the precise form disclosed. Many modifications and variations are possible in light of the above teaching.

What is claimed is:

1. A network system for providing live video based discussion comprising:
a host server for connecting with a plurality of browser clients;
a web site having an embedded code that allows a connection between said host server and each of said plurality of browser clients;
a media server for receiving first live video and audio data from a first individual browser client and second live video and audio data from a second individual browser client;
wherein said host server receives instructions from individual browser clients requesting said first and second live video and audio data and said host server requests said media server to rout said live video and audio data to each individual browser client that requests said live video and audio data;
wherein said media server connects with said individual browser client that requests said first and second live video and audio data and streams said first and second live video and audio data to said individual browser client that requests said first and second live video and audio data; and
a customized flash video player in each of said plurality of browser clients for receiving said first and second live video and audio data, wherein said first and second live video and audio data are continuously synchronized by said customized flash video player.

2. The network of claim 1 wherein said media server divides said first live video and audio data into a first set of video and audio frames and said second live video and audio data into a second set of video and audio frames, said media server marking each of the first set of video and audio frames with a first time stamp and each of the second set of video and audio frames with a second time stamp; and wherein said customized flash video player continuously synchronizes said first and second live video and audio streams by measuring a time difference between said first timestamp and said second timestamp at set intervals; and wherein said customized flash video player slows a stream rate of said second live video and audio stream if the time difference exceeds a predetermined amount of time.

4. The network system of claim 1 wherein said media server further comprises a memory for storing said live video and audio data, wherein said media server stores said live video and audio data in said memory and said browser clients receive said streamed video and audio data from said memory.

5. The network system of claim 1 wherein said browser client further comprises a video module and an audio module for transmitting said live video and audio data to said media server.

6. The network system of claim 1 wherein said host server further receives message data from at least one browser client, the message data routed to said individual browser client that requests said live video and audio data.

7. A network system for providing live video based discussion to a content delivery network comprising:
a host server for connecting with a plurality of browser clients and with a content delivery network;
a web site having an embedded code that allows a connection between said host server and each of said plurality of browser clients;
a data server connected to said host server, said data server receiving message data from said plurality of browser clients;
a media server connected to said host server, the media server receiving live video and audio data from at least one of said plurality of browser clients; and
wherein said host server receives said live video and audio data from said media server and said message data from said data server, said host server streaming said live video and audio data and said message data to said content delivery network.

8. A network system for providing live video based discussion comprising:
a host server for connecting with a plurality of browser clients;
a web site having an embedded code that allows a connection between said host server and each of said plurality of browser clients;
a media server for receiving first live video and audio data and second live video and audio data from individual browser clients, said media server having a memory;
said media server storing said first and second live video and audio data in said memory as first and second stored video and audio data;
wherein said host server receives instructions from individual browser clients requesting said first and second stored video and audio data and said host server requests said media server to rout said first and second stored video and audio data to each individual browser client that requests said first and second stored video and audio data;
wherein said media server connects with said individual browser client that requests said video and audio data and streams said first and second stored video and audio data to said individual browser client that requests said stored video and audio data;
a customized flash video player in each of the plurality of browser clients for receiving said streamed first and second video and audio data; and
wherein said streamed first and second video and audio data is continuously synchronized by said customized flash video player.

9. The network system of claim 8 wherein said host server receives a translation request for said stored video and audio data from a first browser client; wherein said host server sends said translation request to said plurality of browser clients; and wherein a second browser client adds a text file having caption segments comprising a timecode, caption text and a blank line to said stored video and audio data.

10. The network of claim 8 wherein said first recorded video data is divided into a first set of video and audio frames and said second recorded video data is divided into a second set of video and audio frames; wherein said media server marks each of said first set of recorded video and audio frames with a first timestamp and each of said second set of recorded video and audio frames with a second timestamp; said flash video player continuously synchronizes said recorded video and audio streams by measuring a time difference between said first timestamp and said second timestamp at set intervals and increasing a stream rate of said second live video and audio stream if the time difference exceeds a predetermined amount of time.

11. A method for providing live video based discussion via a network comprising:
providing a host server for connecting with a plurality of browser clients;
providing a web site having an embedded code that allows a connection between said host server and each of said plurality of browser clients;
connecting said host server with said plurality of clients;
providing a media server for receiving first live video and audio data from a first individual browser client and second live video and audio data from a second individual browser client;
sending a first live video and audio data from a first individual browser client and second live video and audio data from a second individual browser client to said media server;
sending instructions to said host server from individual browser clients requesting said first and second live video and audio data;
said host server requesting said media server to rout said live video and audio data to each individual browser client that requests said live video and audio data;
connecting said individual browser client that requests said first and second live video and audio data to said media server and
streaming said first and second live video and audio data to said individual browser client that requests said first and second live video and audio data; and
providing a customized flash video player in each of said plurality of browser clients for receiving said first and second live video and audio data, wherein said first and second live video and audio data are continuously synchronized by said customized flash video player.

12. A method of synchronizing two video streams on a client computer comprising:
time-stamping a first video and audio stream;
time-stamping a second video and audio stream;
measuring a time difference between said first video and audio stream;
slowing down said first video and audio stream where the time difference exceeds a predetermined value.
